(19) United States
(12) Patent Application Publication
(10) Pub. No.: US 2003/0088469 A1
(43) Pub. Date: May 8, 2003

(54) Restaurant management system

(76) Inventor: Richard Leifer, Melville, NY (US)

Correspondence Address: KEUSEY, TUTUNJIAN & BITETTO, P.C., 14 VANDERVENTER AVENUE, SUITE 128, PORT WASHINGTON, NY, 11050, US

(21) Appl. No.: 10/195,336

(22) Filed: Jul. 16, 2002

Related U.S. Application Data
(63) Continuation-in-part of application No. 09/797,764, filed on Mar. 5, 2001.
Application No. 09/797,764 is a continuation-in-part of application No. 09/567,454, filed on May 8, 2000.

(51) Int. Cl. G06F 17/60

(52) U.S. Cl. 705/15

(57) ABSTRACT

A restaurant management system that enables the customer to be in direct contact with the server or a fulfillment source at all times, in addition to allowing the restaurant management to monitor service and maintenance throughout the establishment. Keypads are disposed at customer locations and/or service/maintenance locations within the restaurant. The customer keypads are adapted to receive item requests from the customer, while the service/maintenance keypads are adapted to receive information from the service/maintenance personnel to indicate the status of the service or maintenance. The keypads are in wireless communication with a central station and thereby allow a centralized system to monitor and evaluate service efficiency, in addition to controlling service within the establishment. Timers are associated with respective tasks and the fulfillment of the incoming requests from the customers (i.e., directly via keypad or indirectly via service personnel). The timers are checked and determinations as to the efficiency and service of the establishment can be easily made and revised as needed by management.

### CROSS-REFERENCE TO RELATED APPLICATIONS

This application is a Continuation-in-Part of co-pending U.S. patent application Ser. No. 09/797,764 filed Mar. 5, 2001, which is a Continuation-in-Part of U.S. patent application Ser. No. 09/567,454 filed May 8, 2000.

### BACKGROUND OF THE INVENTION

1. Field of the Invention

The present invention relates to restaurant services, and more particularly, to a restaurant management system employing server and service/maintenance personnel systems to increase operation efficiency.

2. Description of the Related Art

One of the primary goals of a restaurant business is to provide prompt, efficient and courteous service to their customers while maintaining food quality. In furtherance of these goals, restaurants often implement electronic systems to help maintain communications between the customer, waiter/server and kitchen.

An example of such system is described in U.S. Pat. No. 4,935,720 which discloses an apparatus for the transmission of information in a restaurant. The apparatus discloses a waiter-restaurant information transfer system in which a principal treatment unit is disposed in the kitchen area. The principal unit includes a set of buttons associated with respective tables or a keyboard that can be operated by food service personnel to provide a display, at a board in the dining room and at a region at which the waiter can pick up prepared food service items. When the waiter responds to the signal at the pickup region, and upon pick up of the food service item, they press a push button or operate a keyboard to cancel the previous display.

U.S. Pat. No. 4,511,161 discloses an identification and control apparatus for service personnel for a restaurant. The disclosed method and apparatus divides the working space of the restaurant into selected stations and for assigning service personnel to these stations. Identification elements are associated with a respective subject layout which comprises a transparent plastic sheet on which are drawn divisions of the restaurant into separate sections and an underlying floor plan showing, on a reduced scale, the physical area of the restaurant. A correlation sheet is secured in proximity to the layout to indicate the particular subject associated with its respective identification element and its station in accordance with the number of stations the restaurant is to be divided at any given time of the day. A plurality of transparent sheets are furnished corresponding to the maximum number of divisions of the restaurant into separate sections.

Both the '720 and '161 patents are directed at organizing restaurant personnel in an effort to maintain an efficient and functional working environment. However, neither the '720 nor '161 patents consider the customer as a factor when implementing an efficient operation scheme. However, one of the most important considerations in a restaurant is their customer service. As such, the customer and the restaurant personnel's service of the customer in an efficient manner is an integral part of successful operation of a restaurant. The most common complaint among restaurant goers is the inability to get the waiter's attention when they would like to order something or request something from their waiter.

U.S. Pat. Nos. 4,250,491 and 5,699,039 disclose various devices for obtaining the waiter/server's attention when the customer requires the same. The '491 patent shows a table signal device that is situated at the customer table and is physically lifted by the customer to signal their need for the waiter/server's attention. A light on the top of the device is illuminated when the customer raises the sign to make it highly visible. The '039 patent discloses a menu stand or similar device that includes a “call waiter” button at its base. When the customer presses the “call waiter” button a thin electroluminescent (EL) surface element mounted on the menu holder that enables the menu holder to be illuminated in order to summon the waiter/server.

The devices disclosed in the '491 and '039 patents require the customer to summon the waiter/server, wait for them to arrive, request the item or items desired and then wait for the waiter to retrieve the requested item(s). This series of events, although common, do not promote, and in fact hinder the efficient operation of a restaurant establishment. Thus, it would be desirable to provide a system that can eliminate this series of inefficient steps and enable the customer to be in direct communication with the waiter during their stay at the restaurant.

### SUMMARY OF THE INVENTION

It is therefore an object of the invention to provide a server call system that increases service efficiency in a restaurant establishment.

This and other objects are achieved in accordance with an embodiment of the present invention in which a server call system comprises a customer transmitter disposed at each customer location within a restaurant and a server receiver in wireless communication with said transmitter and being carried by service personnel with the restaurant. The customer transmitter includes an input keypad adapted to receive customer item requests and a display for displaying a plurality of information to the customer. The server receiver includes a display screen for displaying received item requests from said transmitter and at least one of an audible, visual and tactile indicator for indicating when a customer item request has been received from a customer transmitter.

In another embodiment, a central processing station is provided within the restaurant establishment to administrate communication between all customer location transmitters and server receivers. The central processing station includes all processing, memory and wireless communication protocol to administrate the system. The customer transmitters and server receivers can include transponders so as to enable the central station to identify the location of each transmitter and receiver. In this manner, the central station can administrate communication between the customer location transmitters and server receivers by routing customer item requests to the server receiver of the service personnel most closely located to a service area that is to be used to fulfill the customer item request.

In further embodiments, a front end management system is implemented where service/maintenance keypads are disposed around the restaurant establishment and are in communication with a central station. When service or maintenance is performed in the selected area, the maintenance or service personnel uses the keypad to indicate that the service/maintenance has been performed. The central station is in wireless communication with the keypads, and when an entry is made on the keypad, the central station updates a a service/maintenance database that may be reviewed and monitored by management.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

In the drawings wherein like reference numerals denote similar elements throughout the views:

FIG. 1a is a block diagram of the restaurant management system according to a first embodiment of the invention;

FIG. 1b is a plan view of the customer keypad according to another embodiment of the invention;

FIG. 1c is a side view of the customer keypad according to another embodiment of the invention;

FIG. 2 is a block diagram of the restaurant management system according to a second embodiment of the invention;

FIG. 3 is a diagrammatic representation of a list of request codes implemented according to an exemplary embodiment of the present invention;

FIG. 4 is a further block diagram of the restaurant management system according to the second embodiment of the invention; and

FIG. 5 is a block diagram of a server system according to another embodiment of the invention;

FIG. 6 is a block diagram of the server system according to yet another embodiment of the invention;

FIG. 7 is a block diagram of the server system according to another embodiment of the invention;

FIG. 8 is a perspective view of a server portable point of sale system according to an embodiment of the invention;

FIG. 9 is a block diagram of the restaurant management system according to another embodiment of the invention; and

Figure 10 is a flow diagram showing the processing of incoming commands of the restaurant management system according to an embodiment of the invention.

### DETAILED DESCRIPTION OF PREFERRED EMBODIMENTS

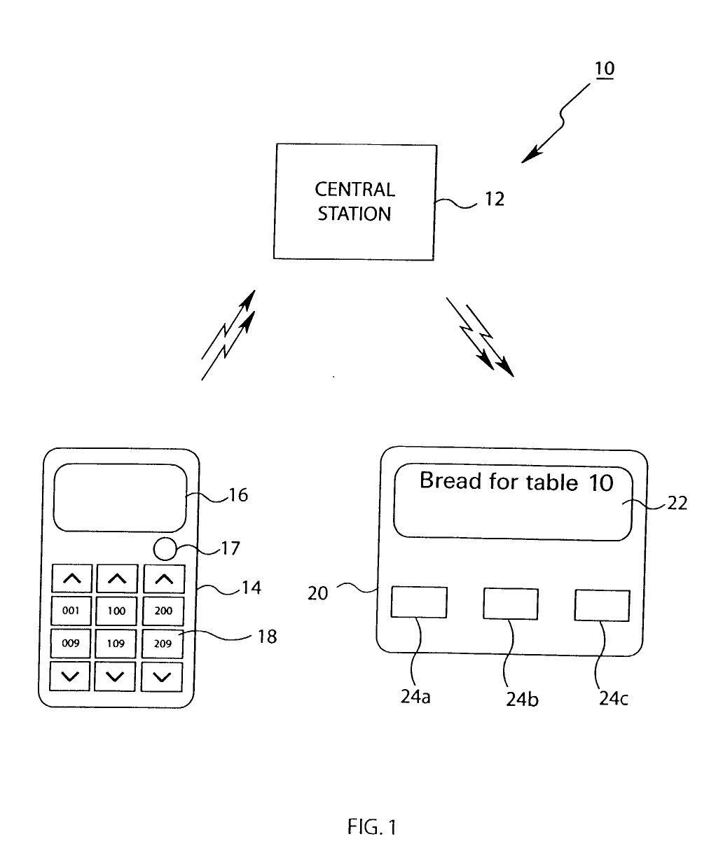

Referring to FIG. 1, there is shown the server call system 10 according to an embodiment of the present invention. The server call system 10 includes a plurality of customer keypad devices 14, a central station 12 in wireless communication with keypad devices 14 and a server paging device 20 also in wireless communication with the central station 12. The Wireless Application Protocol (WAP) implemented by central station 12, keypads 14 and paging devices 20 can be any suitable wireless communication protocol. Those of ordinary skill in the art will recognize that WAP is a secure specification that allows user to access information via handheld wireless devices. WAP supports most wireless networks including, for example, CDPD, CDMA, GSM, PDC, UMTS, etc. It is understood that radio frequency (RF) techniques including, but not limited to, Bluetooth and cellular frequency ranges can also be utilized efficiently in the application contemplated herein.

Central station 12 includes all processing, transmitting, receiving and memory systems necessary to maintain and control the wireless network implemented in the server call system of the present invention. Central station can be implemented, by way of example, using a general purpose computer having radio transmission peripheral devices for transmitting and receiving wireless signals to and from the keypads 14 and server pagers 20. Central station 12 can also be a dedicated processing device designed to include all circuitry, processing and memory required for the present application.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine (e.g, central station) is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying Figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

Keypad 14 includes a plurality of keys 18 and a display 16 for providing the user with a display of the user selected request and possibly a confirmation of sending and receipt of the user request by the central station 12. The confirmation of the sending of an item request may also be provided by a separate visual indicator 17, such as a light or LED. This confirmation indicator 17 may also serve as an indicator for the restaurant that this customer has input a request and is awaiting its fulfillment. For example, indicator 17 may go on solid after a request has been made, and stay on until the request is fulfilled. In this manner the indicator 17 serves a dual function of confirming the sending of a request, and notifying the surrounding area that such request has been made. The plurality of keys 18 can be numeric, alphanumeric of any suitable combination thereof. The number of keys 18 may be increased or decreased depending on specific applications without departing from the spirit of the present invention. By way of example, keys 18 are shown having numeric ranges and up and down arrows for enabling the user to scroll through items while viewing the same on display 16. Keypad may also include an internal memory (e.g., random access memory—RAM) for storing customer item request codes, which are described hereinbelow with reference to FIG. 3.

The paging device 20 includes a display 22 which provides the server the customer request and their respective location within the restaurant. By way of example, display 22 is shown displaying a message “Bread for table 10” which instructs the server to bring bread to table 10. Display 22 may be any suitable type of display including, for example, liquid crystal displays (LCD). The display 22 can also include illumination means or a backlight for easy viewing in dimly lit surroundings. Paging device 20 may include buttons 24a and 24b for reviewing, deleting, storing or otherwise manipulating data received by paging device 20. In addition, a light 24c may be provided which may blink or otherwise provide an additional visual signal to the server that a customer request has been received. Paging device 20 may also include a vibration mode (tactile indicator) that is activated/deactivated by one of the buttons 24a or 24b or a combination of both.

In operation, the keypad devices 14 are located at each table or other customer locations where customers are expected to sit or wait for service. The seats at a bar could also be examples of such locations. The central station 12 is preferably programmed with the geographic position (i.e. customer location) of each keypad device 14. This geographic position layout is typically the table/seating layout for the respective establishment.

Each server/waiter or other service personnel within the restaurant has their own paging device 20 which is a uniquely addressable device, similar to telephone paging devices, so that it is directly addressable by the central station 12. In this manner, the central station 12 can selectively send signals to one or more of the paging devices in response to received service request criteria from the customer keypads. Central station 12 is programmed to receive the keypad transmitted signals, identify their origin (i.e., the customer location from which the keypad 14 has been actuated), and transmit the customer request to the server pager 20 of the server assigned to that customer location. Accordingly, each customer keypad 14 and signals received therefrom by the central station 12 are identifiable as originating from the table or specific customer location of the keypad 14 within the establishment.

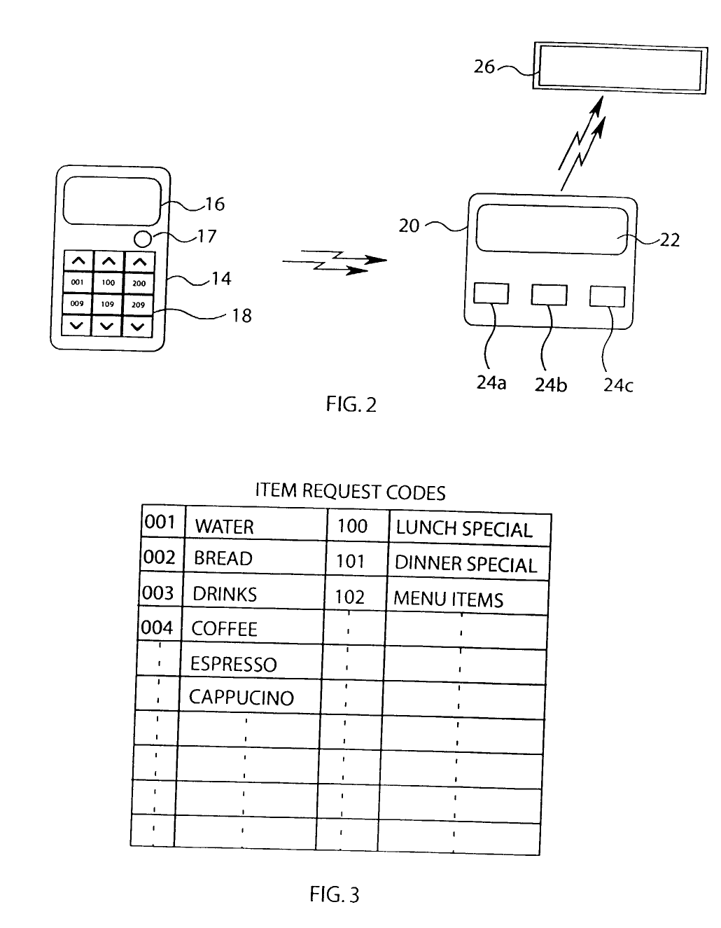

The server carrying paging device 20 is trained to respond to the customer request received via pager 20, thus eliminating the need for customer to obtain the server's attention and subsequently instruct them to retrieve a desired item. In an additional embodiment, a remotely located display connected to the server pager 20 is provided. For example, a remotely located display may be positioned on the server's tray or other convenient location to eliminate the need for the server to go looking at their server pager every time a new customer item request is received. The remotely located display 26 (FIG. 2) is in communication with server pager 20 and as such, can provide a redundant display as that shown on display 22. The disposition of the remotely located display is a matter of design choice, provided it is visually observable by the server, even when their hands are full. This significantly increases the server's ability to efficiently serve the customer and potentially increases the number of customer locations any one server can manage.

FIGS. 1b and 1c show various embodiments of the customer keypad 14 according to the invention. In this embodiment, keypad 14 includes a display screen 16 that is touch-sensitive. As such, the plurality of user operable keys 18 are soft-keys that are generated by the keypad 14 and displayed on display 16. The user may then touch the desired soft-key to effect their chosen action. Through the implementation of soft-keys, the keypad 14 can display various different button layouts for each of the menu screens and the functions of the respective soft-keys can be changed as desired. It also allows each restaurant to custom program the layout of each display provided to the customer via keypads 14. FIG. 1c shows a side view of keypad 14 which includes a communication port 19 that provides the customer with the ability to connect their laptop or other computing device to an online service or remotely located personal computer system. Communication port 19 can be, for example, an RJ-11 telephone modem connection port, an RJ-45 data networking connection port, an IEEE 1394 FireWire™ port, fiber optic or any other suitable known type of communication connection port.

FIG. 3 shows an example of a request code listing that may be a printed sheet located at the respected customer location or may be programmed into the internal memory of keypad 14 and accessible through any suitable operating system, such as, for example, Windows CE®, PalmOS®, EPOC, FLEXOS® and OS/9. One of ordinary skill will recognize that various different operating systems may be used without departing from the spirit of the present invention.

In accordance with a first embodiment of the invention, when a customer inputs a request code into their designated keypad 14, the code will be transmitted to central station which will send the particular request to the server pager 20 to instruct them to fulfill the request by bringing a particular item or service requested to the customer location from which the request originated. The requests can be, for example, ordering menu items or beverages, requesting condiments, requesting the server's attention and requesting the check when appropriate.

FIG. 2 shows a second embodiment of the invention where the central station is eliminated and keypad 14 transmits the customer item requests directly to a server pager 20. In this embodiment, the keypads 14 are programmed to transmit the customer requests to a specific server pager 20 of the server handling the pre-designated customer locations. For example, the WAP can be configured such that a select predetermined number of keypads 14 from predetermined customer locations transmit their customer requests directly to a single predetermined server pager 20. In this arrangement, the restaurant or other establishment is divided into customer locations and service personnel is designated to handle groupings of those customer locations. In other words, each predetermined group of customer locations would have keypads 14 that are configured to transmit to one server pager 20 so as to directly address the server personnel handling that group of customer locations. In addition to the customer requests, keypads 14 may also transmit identification information such as, for example “message received from table 2” to the pager 20 so that the server knows the exact origin of the request in case the server has a question for the customer relating to their request.

In another contemplated embodiment, central station 12 can include a people finding feature, or more particularly a service personnel locating system that enables the central station 12 to route an incoming item request from keypad 14 to the pager 20 of the nearest service personnel available to fulfill such request. Examples of people or object locating systems can be found in U.S. Pat. No. 5,455,851, the entire contents of which are incorporated herein by reference. Other personnel locating system that are used in conjunction with telephone systems are disclosed in U.S. Pat. Nos. 5,515,426, 5,822,418 and 6,009,333, each of which are incorporated herein by reference. The PBX as disclosed in these patents may be substituted with the central station of the present invention.

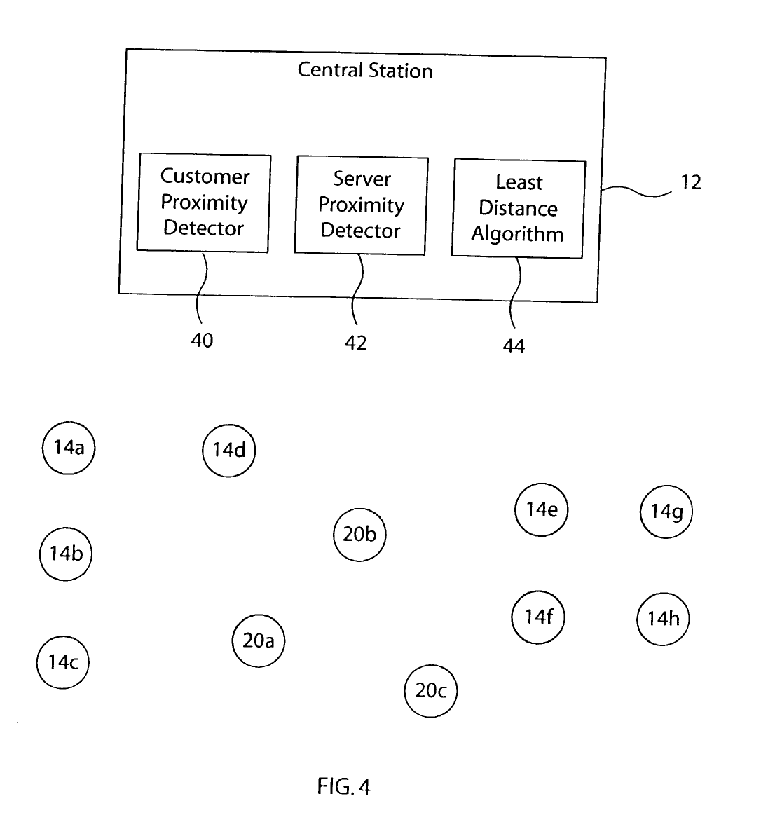

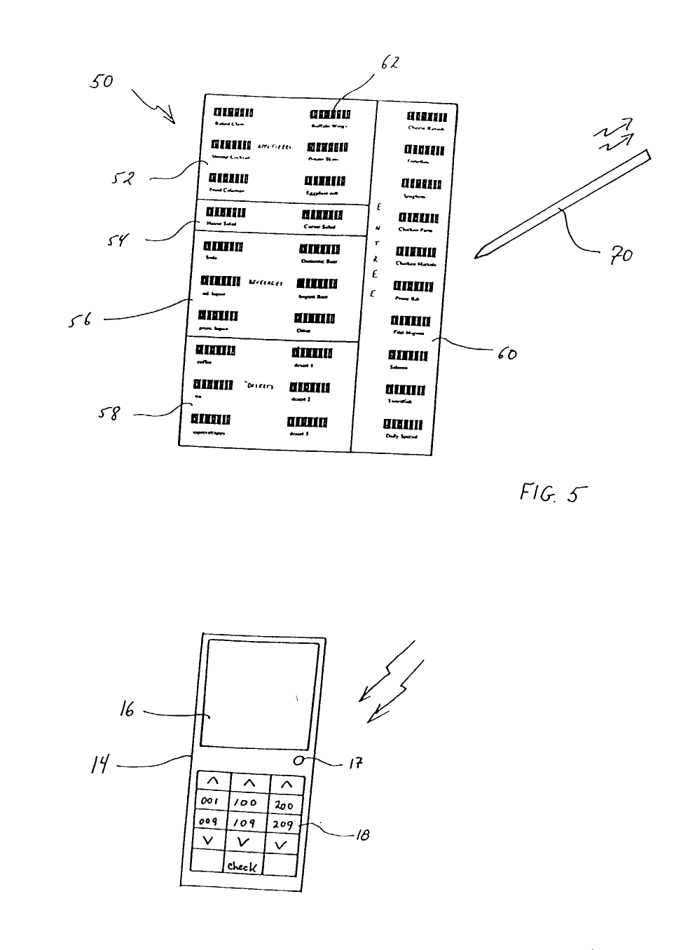

In this alternative embodiment, each server pager 20 and customer keypad 14 includes a transponder that enables the central station 12 to identify and monitor the location of each server within the establishment and their proximity to the customer locations and the food service locations (e.g., kitchen or other server stations). FIG. 4 shows a block diagram representation of a plurality of customer locations 14a-14h and a some server pagers 20a-20c scattered within the restaurant establishment. Thus, for example, when a customer inputs a request into their keypad 14a, central station 12 identifies the request and its origin using a customer proximity detector 40 or other processing means, identifies the server pager 20b most closely located to the service station from which the server would retrieve a requested item or fulfill the request, and directs the request to the identified server's pager 20b. In this example, although server pager 20a is physically closer to customer location 14a, central station routes the customer request to server pager 20b because it has been determined by central station 12 that the server carrying pager 20b is closer to the service area for fulfilling the customer 14a request.

Central station 12 includes a server proximity detector or other similar processing means to dynamically determine the location of each server pager 20 within the establishment, and a least distance algorithm or processor 44 for determining the respective distances between the server pagers and predetermined service areas within the restaurant.

Central station 12 can also be configured to send specific item requests such as food and beverage requests directly to the kitchen and bar, respectively, with subsequent notification to a selected server upon expiration of a predetermined time or receipt by the central station of a completion notice sent from the kitchen or bar when the request has been fulfilled.

In this embodiment, the customer locations need not be grouped or otherwise identified within central station prior to operation of the system. Through the use of transponders, central station 12 will identify the geographic origin of the customer's item request and use that information to route the request to the closest service personnel.

FIG. 5 shows another embodiment of an increased efficiency service system for restaurant applications. As with the previous embodiments, keypad devices 14 are situated at each customer location within the restaurant and include a plurality of different buttons, including a server call button for obtaining the attention of a server. When the server call button is depressed, the server is notified using the pager 20 they are carrying. In addition, the server will carry a clip board or other type of pad having a sheet 50 containing a plurality of barcodes 62, each associated with a particular menu item. Sheet 50 can be broken down into sections by menu item. For example, section 52 are appetizers, section 54 are salads, section 56 are deserts and section 60 are entrees. The server's clip board or pad includes a light pen 70 that enables the server to scan the barcode according to the customers desired order. An example of light pen 70 is shown in U.S. Pat. No. 5,508,504, the entire contents of which is incorporated herein by reference.

During operation, light pen 70 and customer keypad 14 are in wireless communication with the central station 12 (FIGS. 1 and 3). When the customer places their order with the server, the server uses light pen 70 to scan the barcodes 62 corresponding to the customer's request. Once scanned, the customer's order is transmitted to the central station, which not only processes the order information for purposes of fulfillment, but also transmits that information to the customers keypad display 16. Thus, display 16 will display the customer's order as it is placed. In addition to the ordered items, a running total of the order and other information can be displayed on display 16. The use of a barcode sheet 50 enables the restaurant establishment to easily change the menu by simply programming the central station accordingly and providing the server with an updated barcode sheet 50. In addition, one or more barcodes can be supplied for one or more daily specials without requiring a new sheet 50. In this manner, the central station would be re-programmed for the daily special and therefore when the server scans the daily special barcode, it will register the newly programmed daily special.

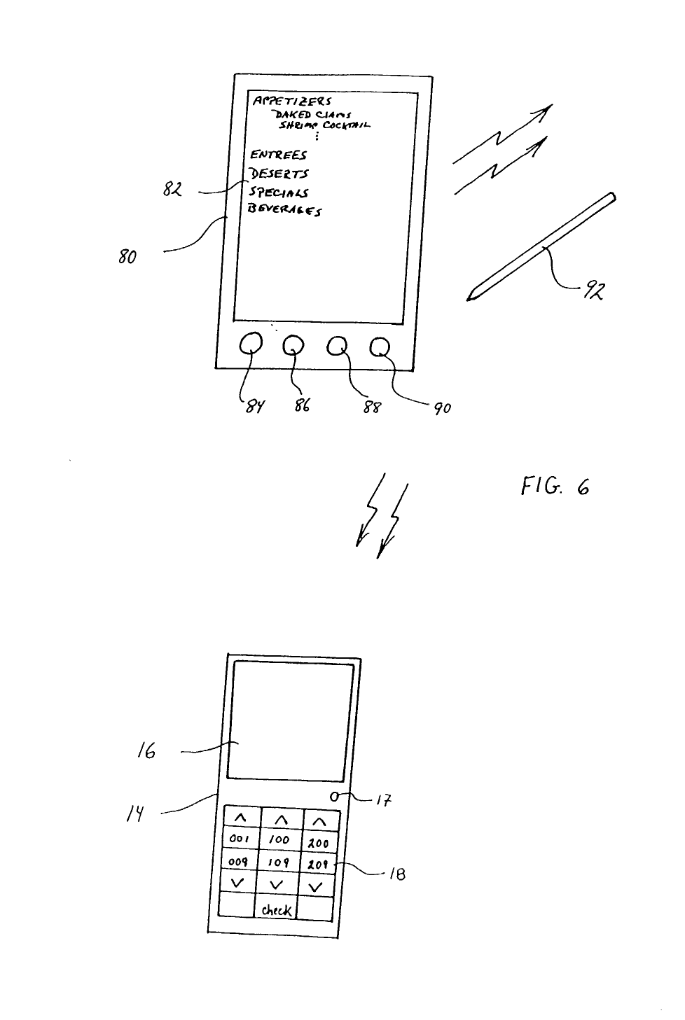

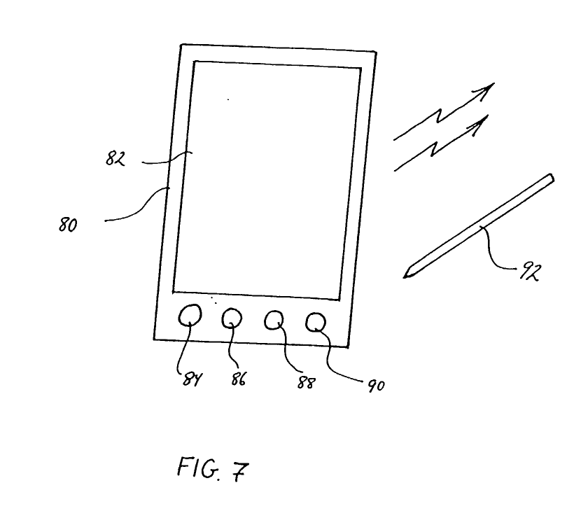

In accordance with another embodiment shown in FIG. 6, rather than the barcode sheet 50, the server carries a personal digital assistant (PDA) type device 80 having a touch sensitive screen 82 and a plurality of buttons 84, 86, 88 and 90. Buttons 84, 86, 88 and 90 can provide a plurality of additional functions, such as, for example, sending the order after placed and input by the server, deleting an ordered item, providing additional information relating to a menu item (e.g., nutritional information including calories, fat content, carbohydrate content, etc, the ingredients used to prepare the item, how the item is prepared, the portion size, etc). A pen device 92 is included with the PDA 80 for inputting information directly onto the screen 82. PDA 80 can be any suitable known type device, such as, for example a PALM® device. The interface between the server and the PDA 80 can be menu driven or may include handwriting recognition applications. As is known in the art, the PDA can be programmed with a plurality of menu items, similar to a WINDOWS® environment, where each category of menu items is listed. When the server uses pen 92 to touch one of the menu items listed, another drop down menu appears listing all the sub-selections available for that menu item. For example, the menu list may be broad menu headings like appetizers, entrees, deserts, specials, etc. When the server touches appetizers with the pen 92, another list pops up listing each of the appetizers available for ordering. A subsequent selection of one from the list will result in the placing of the order. PDA 80 is in wireless communication with the central station and the customer keypad device 14 such that the customer's order is displayed on display 16 as their order is placed. This will enable the customer to see a running total of their order and confirm that their order has been placed as desired.

FIG. 7 shows PDA device 80 that may be alternatively positioned at each customer location. In this embodiment the customer will input their order using pen 92 and PDA display 82. This input can be in the menu driven example described in accordance with the embodiment shown in FIG. 6, or may be a handwritten recognition type input. The customer will have instructions at the customer location for inputting and sending their order information to the central station via PDA 80. The handwriting recognition utilized with the PDA can be, for example, the Graffitti™ handwriting recognition as currently available with PALM devices, or may include any other suitable known available handwriting recognition software that enables the user to substantially handwrite their orders or requests into the PDA 80.

In this embodiment, the customer will also be able to obtain additional information relating to the items ordered. This other information can include nutritional information relating to the ordered items and may also include photographs of the ordered items. The nutritional information may be, for example, a breakdown of the ingredients, calories, fat content, carbohydrates, protein, etc., and may also include the preparation details of each menu item. It is also contemplated that the customer will be able to review the nutritional, preparation and photographic information relating to the menu items prior to ordering the same.

According to a further embodiment of the invention, the customer keypads 14 include game programming information and will provide the customer with the additional ability to play games at their customer location using the keypad. The type of game and programming is a matter of design choice and is preferably determined by the restaurant establishment in which the keypads 14 are disposed. It is contemplated that a gaming company such as, for example, Nintendo of America, Inc., could provide the necessary programming and/or gaming capabilities for the keypad 14. Those of ordinary skill in the art will recognize that there are many different types of games and manners of implementation, too exhaustive to list here. It is understood that the game programming can include removable cartridges or may be simply programmed into the keypads 14.

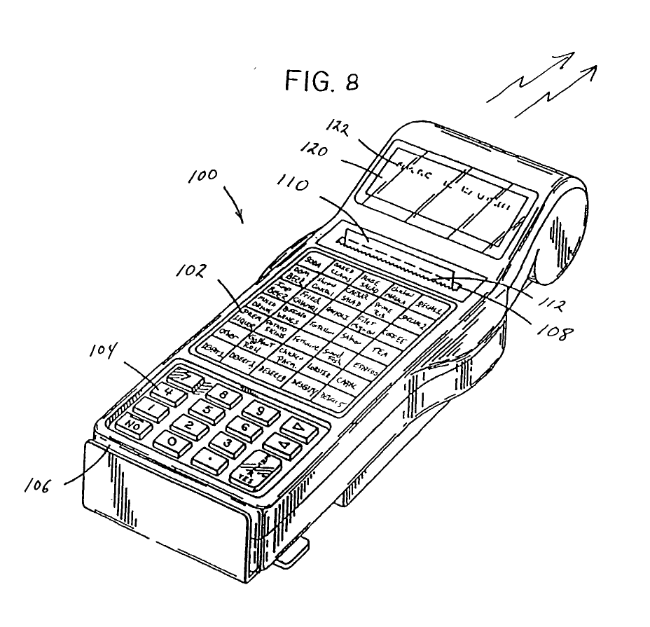

FIG. 8 shows another embodiment of the invention where a portable ordering/order processing device 100 is implemented and in wireless communication with the central station. This point of sale device and its operation is disclosed in U.S. Pat. No. 5,489,773, which is incorporated herein by reference. According to an embodiment of the invention, device 100 is disposed at each customer location and includes a plurality of input buttons 102 corresponding to each menu item available for ordering, a keypad 104 for use in conjunction with the input buttons 102 and a display 120 for displaying information relating to menu items and ordered items. In addition to enabling the customer to place their order and see information relating to the menu items, device 100 can provide the customer with a credit card reader mechanism 106, a printer 108 for printing a receipt 110 and corresponding perforated edge 112 for tearing of the receipt 110. Through the use of the credit card reader 106, the customer may obtain and pay their check without requiring interaction with the server.

In accordance with another embodiment, device 100 may be carried by the server and be in wireless communication with the central station and the customer keypad 14 at each customer location. In this manner, the server can operate device 100, while the customer receives simultaneous confirmation on their display 16. As mentioned previously, the customer will be able to access additional information relating to the menu items and their order on keypad 14 and display 16.

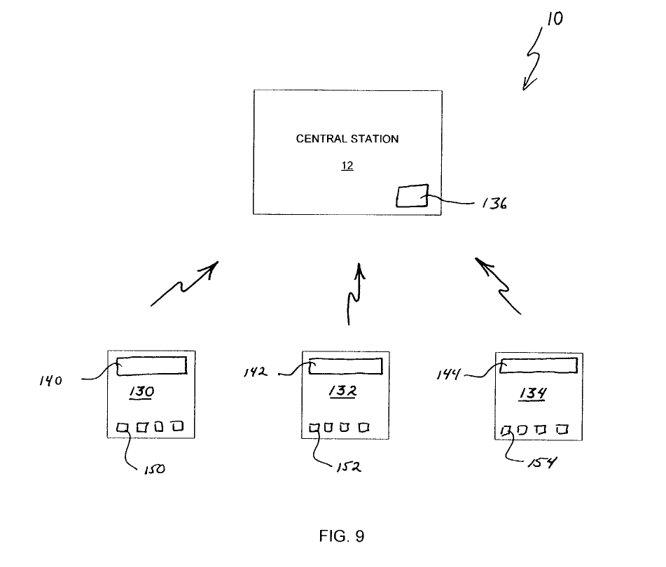

FIG. 9 shows a block diagram of the restaurant management system 10 according to the invention. In this embodiment, keypads or other input devices 130, 132 and 134 are disposed throughout the restaurant in service/maintenance areas and are in communication with the central station. For example, keypad 130 can be disposed in the men's bathroom, keypad 132 disposed in the women's bathroom, and keypad 134 can be disposed in the garbage area of the establishment. When service personnel cleans a bathroom or tends to the garbage in the garbage area, they input a code or press a dedicated button on the respective keypad 130, 132 or 134, in order to notify the central station 12 that such service/maintenance has been performed. Central station 12 then updates its service/maintenance database so that management can readily review the same for efficiency. In this manner, the management can make modifications to scheduling or other aspects of the services provided in order to increase the restaurant efficiency in the service provided.

In accordance with other embodiments, keypads 130, 132 and 134 respectively include displays 140, 142 and 144 and buttons 150, 152 and 154. Accordingly, the central station 12 can send any kind of message to any one or more of the keypads which is then displayed thereon. The messages can be specific or general in nature depending on the service desired in the particular location of the keypad. For example, when keypad 130 is disposed in a bathroom, the message can instruct the service personnel to clean the floor, clean the toilets, replace paper products, etc. In accordance with one embodiment, central station 12 transmits service/maintenance information to the respective keypads 130, 132, and 134 based on predetermined service/maintenance criteria. The predetermined service/maintenance criteria is set by the restaurant personnel and may include, for example, a schedule for service/maintenance in various areas or locations in the restaurant. When the service personnel performs the requested service, they can use the buttons 150 to send a message to the central station 12 to acknowledge that the service was performed in that location.

Central station 12 may be programmed to maintain databases 136 to store information relating to the types of services that need to be performed, the time and date of when the service was performed, etc. Using this database information, the restaurant management personnel can review and monitor the frequency of such service/maintenance to increase the efficiency of the same.

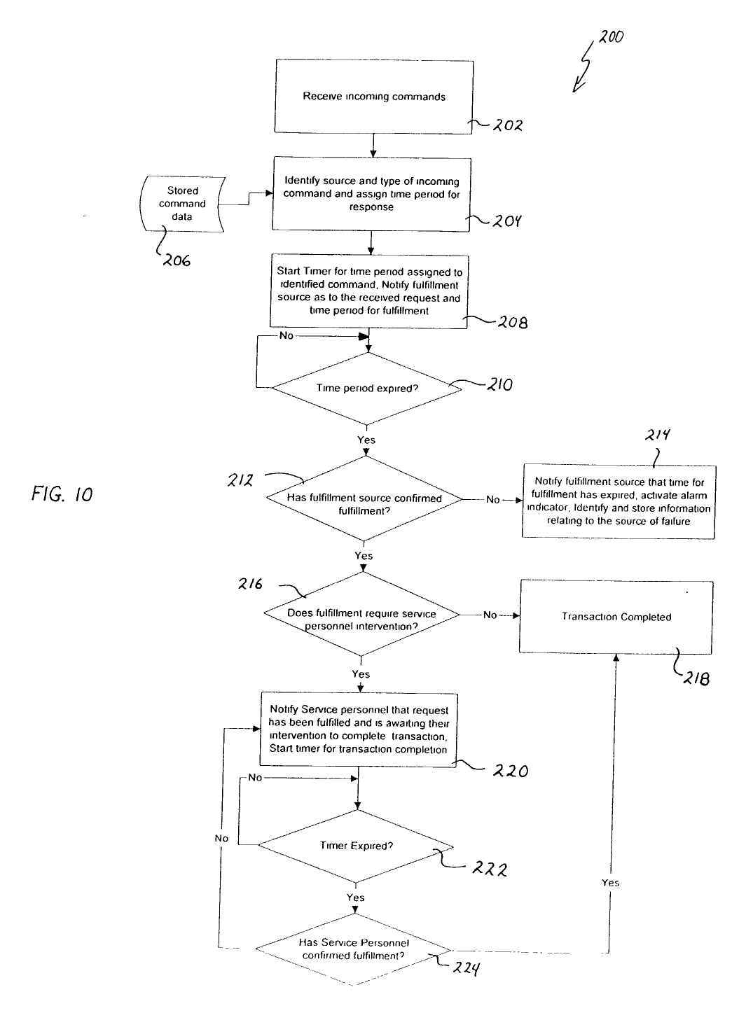

FIG. 10 shows a flow chart 200 representing the handling of incoming commands by the system according to one embodiment of the invention. When any one of the input devices previously mentioned (e.g., keypads 14, pagers 20, PDA 80, keypads 130, 132, 133, keypads 150, 152, 154) sends a command to the central station 12, it is received (step 202) and then identified (step 204). The identification includes the identity of the source of the incoming command (i.e., which input device and location), the type of incoming command (e.g., order, service, maintenance, etc.) and assigns a time period for response to the identified command received based on predetermined criteria for such request. The Central Station 12 includes a data storage area 206 that includes information relating to the sources and types of incoming commands, including preset fulfillment time criteria for predetermined incoming commands.

Once the incoming command source and type has been identified, a timer is started according to the preset fulfillment time criteria for the identified command and a notification message is sent to the fulfillment source for the received incoming command (step 208). A determination is made at step 210 whether the assigned time period has expired. When the time period for fulfillment has expired, central station 12 determines whether the fulfillment source has confirmed the fulfillment of the request (Step 212). When the fulfillment source has not confirmed the fulfillment of the request, they are notified that the time period for fulfillment has expired and activates and alarm or other type of indicator for notifying appropriate personnel as to the status of that fulfillment request (step 214).

When the fulfillment source has confirmed the fulfillment of the received request, it is determined at step 216 whether ultimate fulfillment of the request requires intervention by service personnel (e.g., a waiter to bring the completed order to the requesting table). The “ultimate” fulfillment as referred to herein is when the source if the incoming command has received the requested item or service and the transaction is completed.

If no additional service personnel intervention is required, the transaction is completed (step 218). If additional service personnel intervention is required to complete the transaction for ultimate fulfillment, they are notified accordingly (e.g., via pager 20, PDA 80 or keypad 100) and another timer is started for the transaction completion (step 220). When the timer has expired (step 222) it is determined whether the service personnel has confirmed fulfillment and completion of the transaction with the central station (step 224). If the service personnel has not completed the transaction within the predetermined time, they are notified again (step 220) and an additional timer can be implemented to monitor their completion of the transaction by delivering the requested items from the fulfillment source to the requesting party. When the service personnel has achieved the ultimate fulfillment, the transaction is completed and the service personnel confirms the same with the central station 12 (step 218).

While there have been shown and described and pointed out fundamental novel features of the invention as applied to preferred embodiments thereof, it will be understood that various omissions, substitutions, changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

What is claimed is:

1. A restaurant service system comprising:
a server personal digital assistant (PDA) programmed to include each menu item offered to a customer and having an input pen for inputting information into the server PDA, said PDA containing additional information relating to the menu items.

2. The restaurant service system according to claim 1, wherein said additional information comprises at least one of nutritional, ingredient, preparation, portion size and photographic information relating to each menu item.

3. The restaurant service system according to claim 1, further comprising:
a customer keypad and display device disposed at customer locations within the restaurant; and
processing means in communication with the customer keypad and said server PDA, wherein said display on said customer keypad provides a display of the customer's ordered items as they are entered by the server into the server PDA.

4. The restaurant service system according to claim 3, wherein said server PDA is in wireless communication with the customer keypad.

5. The restaurant service system according to claim 3, wherein said customer keypad and display provides the customer with a display of the ordered items as the server enters the items into the service PDA.

6. The restaurant service system according to claim 3, wherein said customer keypad includes additional information relating to the menu items.

7. The restaurant service system according to claim 6, wherein said additional information comprises at least one of nutritional, ingredient, preparation, portion size and photographic information relating to each menu item.

8. The restaurant service system according to claim 3, wherein said customer keypad further comprises handwriting recognition capabilities, wherein the customer may handwrite their order on said customer keypad display.

9. A restaurant management system comprising:
a service/maintenance personnel panel disposed at locations within a restaurant that require service and/or maintenance; and
a central station in communication with each service/maintenance panel, said service/maintenance panels providing said central station with information relating to the service/maintenance performed at the location of each respective panel.

10. The restaurant management system according to claim 9, wherein each of said service/maintenance personnel panels include a display and at least one button for inputting commands.

11. The restaurant management system according to claim 9, wherein said central station further comprises a service/maintenance database for indicating a status of the service and maintenance performed in the locations containing said service/maintenance panel.

12. The restaurant management system according to claim 9, wherein the information relating to the service/maintenance performed includes the time and date on which the service/maintenance was performed.

13. The restaurant management system according to claim 8, wherein the display on said service/maintenance panel displays instructions to service/maintenance personnel for what service/maintenance needs to be performed in the location of said keypad.

14. The restaurant management system according to claim 13, wherein said central station selectively transmits said instructions to said service/maintenance panels based on a predetermined service/maintenance criteria.

15. A Method for managing a restaurant comprising the steps of:
receiving an incoming request for fulfillment;
assigning a time period for response corresponding to the received request;
forwarding the received request to a fulfillment source and starting a timer corresponding to the assigned time period for the received request;
determining whether the assigned time period has expired; and
determining whether the fulfillment source has confirmed fulfillment of the received request when the time period has expired.

16. The method according to claim 15, further comprising the steps of:
determining whether ultimate fulfillment of the received request requires service personnel intervention;
notifying the service personnel that the received request has been fulfilled by the fulfillment source and requires intervention for ultimate fulfillment when it has been determined that service personnel intervention is required;
starting a timer upon notifying the service personnel of their required intervention for ultimate fulfillment; and
determining whether the service personnel has confirmed ultimate fulfillment by delivering the requested item to the requesting customer.
